(19) United States
(12) Patent Application Publication
(10) Pub. No.: US 2023/0141765 A1
(43) Pub. Date: May 11, 2023

(54) SYSTEM AND METHOD FOR WORKING ON A TRACK WITH A TRACK MAINTENANCE MACHINE

(71) Applicant: Plasser & Theurer Export von Bahnbaumaschinen Gesellschaft m.b.H., Vienna (AT)

(72) Inventors: Klaus FREUDENTHALER, Alberndorf in der Riedmark (AT); Nikolaus MATZINGER, Oberneukirchen (AT); Martin BUERGER, Linz (AT); Gerald ZAUNER, Wilhering (AT)

(73) Assignee: Plasser & Theurer Export von Bahnbaumaschinen Gesellschaft m.b.H., Vienna (AT)

(21) Appl. No.: 17/918,504

(22) PCT Filed: Apr. 21, 2021
(86) PCT No.: PCT/EP2021/060393

§ 371 Date: Oct. 12, 2022

(30) Foreign Application Priority Data
May 19, 2020 (AT) A 50438/2020

(51) Int. Cl. E01B 35/00; E01B 27/17; G06V 20/54; G06V 10/24; G06V 20/20; H04N 7/18

(52) U.S. Cl. CPC E01B 35/00; E01B 27/17; G06V 10/243; G06V 20/20; G06V 20/54; H04N 7/185

(57) ABSTRACT

The invention relates to a control and operating system for working on a track with a track maintenance machine, with at least one machine frame movable on rail-based running gears, comprising working devices , a sensor and measuring system for recording the position data of the working devices and for detecting objects of the track, in particular sleepers, rails, and, as the case may be, obstacles, and further comprising an arrangement of cameras for optical detection of the working devices and the working areas. It is provided that a control station without free visual range of a respective working device is set up at a location inside or outside the track maintenance machine and that the control station comprises a display device for virtual operation, control, and/or monitoring of the track maintenance machine. This achieves greater flexibility during working operation, an extension of the controlling and operating options, and a significant increase in safety and ergonomic design at the workstation.

### FIELD OF TECHNOLOGY

The invention relates to a control and operating system for working on a track with a track maintenance machine, with at least one machine frame movable on rail-based running gears, comprising working devices, a sensor and measuring system for recording the position data of the working devices and for detecting objects of the track, in particular sleepers, rails, and, as the case may be, obstacles, and further comprising an arrangement of cameras for optical detection of the working devices and the working areas. In addition, the invention relates to a method for operating the system.

### PRIOR ART

Universal tamping machines, which are track maintenance machines that are used both for tamping straight track sections and for tamping turnout sections. In order to be able to manage the latter field of application, a special design of the work units as well as additional equipment are required. The effort required to operate and controI such a machine is considerably greater and requires, in addition to extensive training, an appropriate familiarisation and instruction.

Such a track maintenance machine usually consists of two rear cabs and two work cabs. Hence, the area for the operator consists of two workstations in separate locations for operating the respective work units and devices. Due to the complexity and design of the machines, the operator does not always have view of the different working areas, or sometimes only to a limited extent. Since there are two separate work cabs, the operators have to communicate with each other via an intercom system.

For the best possible, albeit limited, view of the work process, the work cabs must be positioned very close to the work units. This leads to limited installation spaces and the operators have to accept cramped, ergonomically poor working situations with an added increased risk of operating errors. In addition, there are dangerous cab accesses, as the cabs are arranged on machine devices that partly move along with the machine. There is an increased risk of crushing; access is only possible when the machine and the working devices are at a standstill. Due to this close arrangement of the cab in the working area, the operator is exposed to high physical stress due to constant accelerations, vibrations, and jolting.

AT 519 739 A4 describes a method for controlling a track maintenance machine, in particular a turnout tamping and/or universal tamping machine, wherein position data of track objects (sleepers, rails, obstacles) are detected by means of a sensor system. A camera is pointed at the machine’s work units to transmit real-time recordings to a display device in an operator’s cab. Furthermore, the working positions of the work units are identified by a sensor system and also displayed on the display device, so that the working positions of the work units can be changed via operating elements even before the work sequence is carried out

### SUMMARY OF THE INVENTION

The object of the invention is to provide a track maintenance machine of the kind mentioned above with greater flexibility during working operation, an extension of the controlling and operating options as well as improved support for the operating staff compared to prior art. Furthermore, a significant increase in safety and ergonomic design at the workstation is to be achieved. In addition, a method for working on a track by means of the system is indicated.

According to the invention, these objects are achieved by way of a system according to claim 1 and a method according to claim 10. Dependent claims refer to advantageous embodiments of the invention.

It is provided that a control station without free visual range of a respective working device is set up at a location inside or outside the track maintenance machine and that the control station comprises a display device for virtual operation, control, and/or monitoring of the track maintenance machine. Positioning the control station independently of the operator’s view of the respective working device and the working area enables the use of significantly larger spaces and/or cabs for the machine operator’s workstation. Better design options significantly increase comfort and ergonomic design of the workstation while reducing the risk of operating errors. As classic arrangement in the track maintenance machine itself, it guarantees the operating staff safe access to the workstation outside the danger zones for almost all machine versions.

The comprehensive term of a working device includes complex work units, such as tamping units for tamping the track, compaction units for compacting the ballast structure. It also includes simpler devices, for example lifting hooks or blades for distributing bulk material, as well as material handling systems and drive units.

In a further development, it is provided that the control station comprises a display device that is set up to display video/image recordings and/or additional information for supporting the operator. This gives the operator a clear view of working devices and working areas thanks to real-time images. It is possible to choose between different views and representations. In addition, supporting information is displayed to the operator for those working devices that are actively in use. These are, for example, graphic markings of obstacles in the working area; possible travel paths of working devices and tools; limiting values for work processes, warnings, indications, and messages of a ny kind.

One embodiment provides that the display device is designed with at least one industrial panel, a flat screen monitor, and/or a video projector. The use of industrial panels or flat screen monitors is preferred in this case, as they provide good image reproduction despite possibly influencing environmental situations such as direct sunlight/daylight or reflections. Video projectors are also used as display devices when the space conditions at the control station, a desired flexibility in rooms used for a variety of purposes, or only temporary use for work assignments require it.

In this context, it is favourable if the display device is designed with industrial panels and/or flat screen monitors with touch screen functionality for operator input. Such an input option offers the operator an additional, intuitive selection and/or input of values and/or predefined commands in addition to other operating elements in the case of display devices arranged within easy reach of the control station. For example, the system acknowledges indications, sets machine parameters, or selects virtually defined working areas.

It is advantageous if the control station is equipped with seats for two machine operators in addition to operating elements.

Due to their high functionality, larger track maintenance machines and also e.g. extensive track renewal and maintenance trains require several operators in full operation. In this way, different working devices are operated independently of the selected seat. This means that the same work process can be carried out from one seat alone, from the other seat alone, or from both seats together. Furthermore, this design of the control station offers operating staff special advantages during training and familiarisation. An example of this is parallel, supportive intervention by a second operator during work processes. An intercom system for communication between operators, previously required due to separate work cabs on track maintenance machines, is no longer required. The concentration of several seats and operating elements at only one control station also stands out through savings in manufacturing costs. Time-consuming wiring work between separate control stations becomes obsolete and considerable material savings are achieved. Similarly, it also makes sense to set up core IT components such as computer systems, computing and control units centrally at the same location.

A further solution provides that the control station is set up with a seat for one single machine operator in addition to operating elements. If the machine type or a restricted operating location requires it, only one seat is available. In other cases, two or more control stations are operated with only one seat each at different locations.

In a useful further development, the cameras for optical detection of the working devices and the working areas are coupled with a computing unit, which is further coupled to a machine control by means of a higher-level computer system.

This allows capturing larger image/video sections without obscured or poorly visible areas. In the process, a distortion correction of the individual camera images, or also a merged, realistic overall representation of the working device and/or the working area takes place.

Furthermore, it is advantageous if the cameras for optical detection are designed as so-called 3D cameras. 3D cameras are used to identify the size of objects and their position in space. Thus, in support of or as an alternative to the sensor and measuring system, the track position and/or obstacles in the working area are identified. The images from the 3D cameras can be fused into a 3D model, a so-called Digital Twin, which additionally offers operators the possibility to select the perspective themselves and to change it at any time during operation.

A design for exchanging information and data to control, operate, and monitor the track maintenance machine between the control station and the higher-level computer system comprises a secure form of transmission, in particular a VPN tunnel via a VPN router. For a secure, protected remote access to the machine, a stable connection via VPN tunnel is preferably selected. This is particularly useful for a control station in a central system unit located at a distance from the track maintenance machine.

In the method according to the invention for operating the system, the track maintenance machine is operated, controlled, and/or monitored virtually via a control station. This allows one or more operators to fully control and monitor the track maintenance machine with all its working devices and working areas. The control station can be set up at any location.

In a further development of the method, it is provided that, after the video/image recordings have been captured by the ca meras, a representation of the working devices, which has been assembled, rectified, and distortion-corrected by the computing unit, is displayed at the control station via the display device. This gives the operator a coherent, realistic image of the respective work situation and keeps both the working devices as well as the working areas in view. This form of processing the video/image recordings achieves a better perception of depth information.

It is advantageous if the video/image recordings of the cameras are displayed in real time at the control station via the display device. This enables fast recognition and reaction when controll ing and monitoring the work processes.

A further embodiment of the method provides that ad ditional information, indications, and/or warnings on the ongoing work process are displayed as text, symbols, and/or graphic representations of any kind at the control station via the display device to support the operator. This addition to the real-time information provides the operator with ad ditional support in the ongoing work process and significantly reduces the likelihood of operating the machine incorrectly. For example, the messages highlight critical machine and process parameters or mark special spots in the displayed working area that require manual intervention or acknowledgement by the operator.

In one embodiment, it is further useful if the position data recorded by the sensor and measuring system is evaluated by a higher-level computer system and compared with preset values and that a fully automatic actuation of the working devices is carried out by an algorithm via the machine control. Depending on the machine type and the respective working device, different actual values are determined. These values can contain a wide range of information about position, orientation, or status of the working device as well as parameters of the work process, and they are compared with stored target values. In fully automatic mode, the algorithm controls the working device directly without the operator’s intervention after evaluating the data. If the system detects irregularities, such as obstacles in the working area or if parameter limits are reached, the work process stops immediately and the machine is brought to a standstill.

A further development provides that the position data recorded by the sensor and measuring system are evaluated by a higher-level computer system and compared with preset values, and that the following work steps of the working devices are displayed as text and/or in graphic form on the display device by an algorithm, with these steps being carried out only after the operator’s confirmation and/or modification by the machine control actuating the working devices correspondingly. This makes it possible to check the upcoming work process and the determined working positions without foregoing the advantages of autom atically actuating the work units. This way, the operator can intervene in a corrective manner as needed.

### BRIEF DESCRIPTION OF THE DRAWINGS

ln the following, the invention is explained by way of example with reference to the accompanying figures. The following figures show in schematic illustrations:

FIG. 1 Side view of a track maintenance machine for working on a track with previous arrangement of the operator’s cab (prior art)

FIG. 2 Side view of a track maintenance machine for working on a track with new arrangement of the control station

FIG. 3 Block diagram of the system setup

### DESCRIPTION OF THE EMBODIMENTS

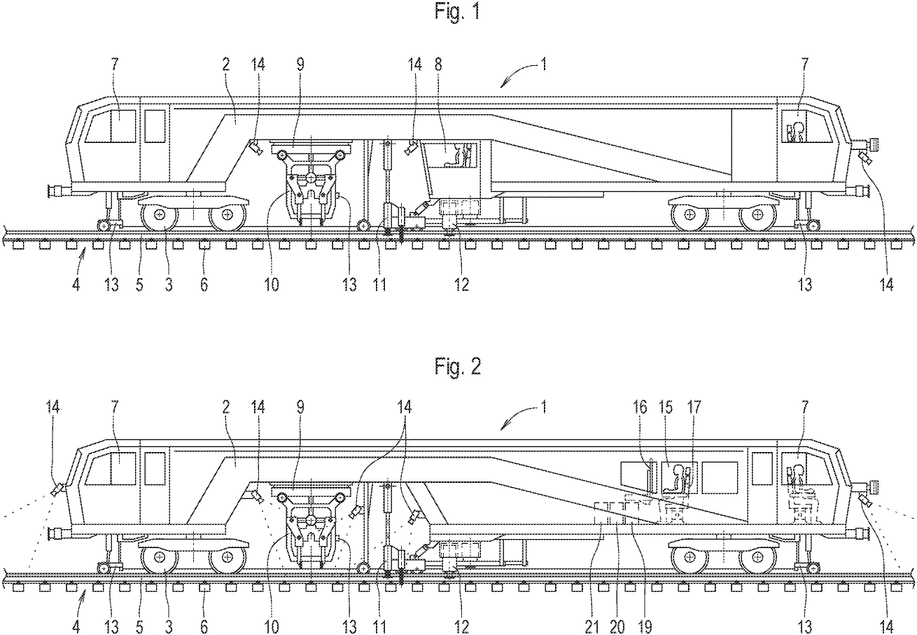

The track maintenance machine 1 shown in FIG. 1 represents the prior art of a discontinuous-action track tamping machine for tamping a track 4. Track is generally understood to be the totality of rails 5, sleepers 6, superstructure, ballast, turnout parts, overhead contact line and signalling equipment. In addition to a ballast structure, the second variant of the superstructure construction, the so-called ballastl ess track, is also relevant for the present invention in connection with various track maintenance machines.

As an alternative to the example shown in FIG. 1, the vehicle frame of a continuous-action track tamping machine is supported on rail-based running gears 3 and a movable satellite comprises the machine frame 2. A rear cab 7 is arranged on the end faces of the machine. In a simple variant of the present track maintenance machine 1, an operator’s cab 8 is provided with view of the working devices A arranged adjustably against the machine frame 2. Nevertheless, not all working devices A and working areas are fully visible to the operating staff from the operator’s cab 8. The working area is defined as the area in which the respective working device 9, 10, 11, 12 can be freely manipulated in its orientation and position.

The machine design shown here comprises as working devices A a turning and shifting work unit suspension 9, a tamping unit 10, a lifting and lining unit 11, and an additional lifting unit 12 for maintaining turnouts. In the case of larger track maintenance machines or extensive track renewal/rehabilitation trains, additional ope rator cabs are used in addition to other working devices. A simple arrange ment of cameras 14 is set up in the area of the working devices A, which includes the front end of the track maintenance machine 1 as seen in the working direction, which is the right end in the figure illustration. The cameras 14 capture limited sections of the working areas and the track 4 and transmit them to the operator’s cab 8. An installed sensor and measuring system 13 records the track geometry as well as all objects on the track 4, in particular rails 5, sleepers 6, and possible obstacles in the working area. The sensor and measuring system 13 is also used to identify operating parameters and the positions of the working devices A.

In FIG. 2, the operator’s cab 8 arranged in the area of the working devices A has been removed as compared to FIG. 1. The machine equipment concerning the working devices A is identical to the track maintenance machine 1 in FIG. 1. By removing the operator’s cab 8, a safe and comfortable control station 15 is now set up for the operating staff in the protected inner area of the track maintenance machine 1. Around this control station 15, among other things, a display device 16, a seat 17, and operating elements 18 are arranged in such a way that they can be operated or actuated ergonomically by the operator. In the case of more extensive track maintenance machines, this control station 15 may also comprise two or more seats 17. An extended arrangement of cameras 14 depicts all working areas and both end faces of the track maintenance machine 1 and transmits this video/image data to a centrally arranged computing unit 19. A machine control 20 and a higher-level computer system 21 are also centrally arranged.

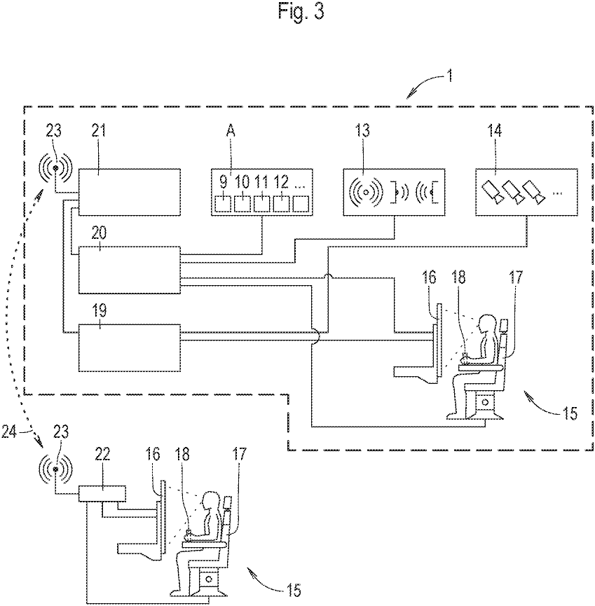

A block diagram of the system setup describes the interaction of the system components in FIG. 3. Starting from the control station 15, a touch screen input function of the display device 16 is preferably provided for the operator. In this case, the display device 16 as well as the operating elements 18 at the control station 15 for entering control and operating commands are coupled to the machine control 20. The operating elements 18 have a varied design; multi-axis, joystick-like input instruments, switches, buttons, touch elements, and/or keyboards can be used here. Video/image data from the cameras 14 is transmitted to the display device 16 as unprocessed, or as processed (e.g. assembled and distortion-corrected) video information in near real time, as specified by the operator. The cameras 14 can be designed as so-called HDR cameras (High Dynamic Range) or xHDR cameras, depending on the requirements in some countries of operation with particularly strong solar radiation. This design can compensate for large differences in brightness in the image area to be captured better than the human eye. The results are high-contrast images with high information content.

The components of the sensor and measuring system 13 are coupled with the machine control 20 and also with the higher-level computer system 21, where all the information received about the ongoing work process is processed and evaluated by algorithms. For actuating and monitoring the working devices A, these are coupled to the machine control 20, with the actuation being carried out either in manual mode directly by the operator via the operating elements 18, or in automatic mode directly by the machine control 20 and/or the higher-level computer system 21. Both the computing unit 19 and the machine control 20 are each directly connected to the higher-level computer system 21 as the highest instance.

information on the ongoing or pending work process (e.g. warnings, graphic representation) that shows up on the display device 16 as additional support for the operator together with the real-time recordings originates in the higher-level computer system 21. This is where the data and signals (e.g. a detected obstacle) fed in by the cameras 14 and the sensor and measuring system 13 are processed. The result of this evaluation is output to the display device 16 via the computing unit 19 and there it is displayed to the operator as an image and/or video overlay.

In case of a control station 15 located outside the track maintenance machine 1, all information and data streams required for operation, control, and display are recorded in a client 22 and coupled to the higher-level computer system 21. of the track maintenance machine 1 via a data link 24 in a bidirectional manner. This coupling is preferably done via a secured VPN tunnel connection between two transmission units 23.

1. A control and operating system for working on a track with a track maintenance machine, with at least one machine frame movable on rail-based running gears, comprising working devices, a sensor and measuring system for recording the position data of the working devices and for detecting objects of the track, in particular sleepers, rails , and, as the case may be, obstacles, and further comprising an arrangement of cameras for optical detection of the working devices and the working areas, wherein a control station without free visual range of a respective working device is set up at a location inside or outside the track maintenance machine and in that the control station comprises a display device for virtual operation, control, and/or monitoring of the track maintenance machine .

2. The system according to claim 1, wherein the control station comprises a display device that is set up to display video/image recordings and/or additional information for supporting the operator.

3. The system according to claim 2, wherein the display device is designed with at least one industrial panel, a flat screen monitor, and/or a video projector.

4. The system according to claim 3, wherein the display device is designed with industrial panels and/or flat screen monitors with touch screen functionality for operator input.

5. The system according to claim 1, wherein the control station is equipped with seats for two machine operators in addition to operating elements.

6. The system according to claim 1, wherein the control station is set up with a seat for one single machine operator in addition to operating elements.

7. The system according to claim 1, wherein the cameras for optical detection of the working devices and the working areas are coupled with a computing unit , which is further coupled to a machine control by means of a higher-level computer system .

8. The system according to claim 1, wherein the cameras for optical detection are designed as so-called 3D cameras.

9. The system according to claim 1, wherein a secure form of transmission, in particular a VPN tunnel via a VPN router is set up for exchanging information and data between the control station and the higher-level computer system to control, operate, and monitor the track maintenance machine .

10. A method for operating a system according to claim 1, wherein the track maintenance machine is operated, controlled, and/or monitored virtually via a control station.

11. The method according to claim 10, wherein after the video/image recordings have been captured by the cameras a representation of the working devices which has been assembled, rectified, and distortion-corrected by the computing unit is displayed at the control station via the display device.

12. The method according to claim 10, wherein the video/image recordings of the cameras are displayed in real time at the control station via the display device.

13. The method according to claim 10, wherein additional information, indications, and/or warnings on the ongoing work process are displayed as text, symbols, and/or graphic representations of any kind at the control station via the display device to support the operator.

14. The method according to claim 10, wherein the position data recorded by the sensor and measuring system is evaluated by a higher-level computer system and compared with preset values and that a fully automatic actuation of the working devices is carried out by an algorithm via the machine control.

15. The method according to claim 10, wherein the position data recorded by the sensor and measuring system are evaluated by a higher-level computer system and compared with preset values, and in that the following work steps of the working devices are displayed as text and/or in graphic form on the display device by an algorithm, with these steps being carried out only after the operator’s confirmation and/or modification by the machine control actuating the working devices correspondingly.
